(19) United States
(12) Patent Application Publication
(10) Pub. No.: US 2008/0050639 A1
(43) Pub. Date: Feb. 28, 2008

(54) Bipolar flow field plate assembly and method of making the same

(76) Inventor: Michael Medina, Vancouver (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 11/509,325

(22) Filed: Aug. 23, 2006

(51) Int. Cl. H01M 8/02; H01M 8/04

(52) U.S. Cl. 429/38; 429/26

(57) ABSTRACT

A bipolar flow field plate assembly comprising an anode plate assembly and a cathode plate assembly, each further comprising an anode flow field plate and a cathode flow field plate, respectively. The anode and cathode flow field plates each comprise an active surface and an inactive surface. The anode and cathode plate assemblies comprise an electrically-insulating frame attached to the active surfaces of the anode and cathode flow field plates around a peripheral edge thereof, and an inner frame attached to the inactive surfaces of the anode and cathode flow field plates around an opposing peripheral edge thereof. The inactive surfaces of the anode ad cathode flow field plates cooperate to form a coolant field therebetween. Methods for making the bipolar flow field plate assembly are also disclosed.

### BACKGROUND OF THE INVENTION

1. Field of the Invention

The present invention generally relates to bipolar flow field plate assemblies for fuel cells, as well as to methods of making bipolar flow field plate assemblies.

2. Description of the Related Art

Electrochemical fuel cells convert reactants to generate electric power and reaction products. Electrochemical fuel cells generally employ an electrolyte interposed between two electrodes, namely a cathode and an anode, to form an electrode assembly, which is typically interposed between two electrically conductive flow field plates or separator plates made of carbonaceous, graphitic, and/or metallic materials. These flow field plates act as current collectors, provide support for the electrodes, and provide passages for the reactants and products. Such flow field plates may contain channels to direct the flow of reactants to the anode and the cathode, and to remove excess reactants and their reaction products, such as water formed during fuel cell operation.

Fuel cells may employ bipolar flow field plates having an anode flow field on one surface and a cathode flow field on the opposing surface. Alternatively, a bipolar flow field plate may be employed having an anode flow field plate with an anode flow field on its active surface, and a cathode flow field plate with a cathode flow field on its active surface, joined together around their peripheral edges to form coolant flow field between their inactive surfaces. In such cases, the bipolar flow field plate is sealed such that the coolant does not leak from the fuel cell.

Typically, a number of fuel cells are electrically coupled in series to form a fuel cell stack. The fuel cell stack may contain supply and exhaust manifolds for directing the flow of reactants to/from the fuel cell stack. Manifold openings are typically formed in an extended area of the flow field plate, and in fluid communication with corresponding manifold openings of adjacent flow field plates to form fluidly connected manifolds for each of the various fluid streams.

For metallic flow field plates, manifold openings and flow channels are typically formed by a stamping process. However, formation of manifold openings in each of the flow field plates by stamping is not desirable because the metallic plates may warp during the stamping process. In addition, when stamping flow channels in the flow field plates, reciprocal features must be formed on opposing sides of the flow field plates. For example, if a channel is stamped onto one side of the plate, a reciprocal landing will protrude from the opposing sides of the plate. Thus, it is not possible to form certain features on directly opposite sides of a stamped metal plate.

As a result, there remains a need for bipolar flow field plates, particularly for metallic bipolar flow field plates, that lessen or avoid these problems. The present invention addresses this issue and provides further related advantages.

### BRIEF SUMMARY OF THE INVENTION

Briefly, the present invention relates to a bipolar flow field plate assembly comprising an anode flow field plate, a cathode flow field plate, and a plurality of frames that seal the anode flow field plate to the cathode flow field plate to form a sealed bipolar flow field plate assembly. Methods for making a bipolar flow field plate assembly are also disclosed.

In one embodiment, the bipolar flow field plate assembly comprises an anode flow field plate and a cathode flow field plate, each having an active surface and an opposing inactive surface; an anode plate assembly comprising an electrically-insulating anode frame attached to the active surface of the anode flow field plate around a peripheral edge thereof and an anode inner frame attached to the inactive surface of the anode flow field plate around an opposing peripheral edge thereof; and a cathode plate assembly comprising an electrically-insulating cathode frame attached to the active surface of the cathode flow field plate around a peripheral edge thereof and a cathode inner frame attached to the inactive surface of the anode flow field plate around an opposing peripheral edge thereof; wherein the inactive surfaces of the anode and cathode flow field plates, respectively, cooperate to form a coolant flow field therebetween.

In another embodiment, the anode and cathode frames are adhesively joined around the perimeter of the anode and cathode flow field plates, such that the inactive surfaces of the anode and cathode flow field plates face each other, to form a bipolar flow field plate assembly. In yet another embodiment, at least one of the anode frame, the cathode frame, and the inner frame further contains at least one manifold opening. In another embodiment, the inactive surfaces of the anode and cathode flow field plates, respectively, cooperate to form a coolant flow field therebetween.

In another embodiment, a method of making a bipolar flow field plate assembly comprises the steps of: providing an anode flow field plate and a cathode flow field plate, each having an active surface and an opposing inactive surface; forming an anode plate assembly by attaching an electrically-insulating anode frame to the active surface of the anode flow field plate around a peripheral edge thereof, and attaching an anode inner frame to the inactive surface of the anode flow field plate around an opposing peripheral edge thereof; forming a cathode plate assembly by attaching an electrically-insulating cathode frame to the active surface of the cathode flow field plate around a peripheral edge thereof, and attaching a cathode inner frame to the inactive surface of the cathode flow field plate around an opposing peripheral edge thereof; and assembling the anode plate assembly and the cathode plate assembly such that the inactive surfaces of the anode and cathode flow field plates, respectively, cooperate to form a coolant flow field therebetween.

In further embodiments, the anode plate assembly is adhesively attached to the cathode plate assembly by applying an adhesive to at least one of the anode and cathode frames, thereby providing a sealed bipolar plate. Alternatively, an injection-moldable material may be injected between the anode and cathode plate assemblies to attach the anode plate assembly to the cathode plate assembly.

These and other aspects of the invention will be evident upon review of the following disclosure and attached figures.

### BRIEF DESCRIPTION OF THE SEVERAL VIEWS OF THE DRAWINGS

In the figures, identical reference numbers identify similar elements or acts. The sizes and relative positions of elements in the figures are not necessarily drawn to scale. For example, the shapes of various elements and angles are not drawn to scale, and some of these elements are arbitrarily enlarged and positioned to improve figure legibility. Further, the particular shapes of the elements, as drawn, are not intended to convey any information regarding the actual shape of the particular elements, and have been solely selected for ease of recognition in the figures.

FIG. 1A is an exploded perspective view of a bipolar flow field plate according to one embodiment of the present invention.

FIG. 1B shows a top view of the bipolar flow field plate of FIG. 1A.

FIG. 2A shows a cross-sectional view of a manifold opening at section A-A of FIG. 1B.

FIG. 2B shows a cross-sectional view of the bipolar separator plate according to another embodiment of the present invention.

FIG. 3A is an exploded perspective view of a bipolar flow field plate according to another embodiment of the present invention.

FIG. 3B shows a top view of the bipolar flow field plate of FIG. 3A.

### DETAILED DESCRIPTION OF THE INVENTION

Unless the context requires otherwise, throughout the specification and claims which follow, the word “comprise” and variations thereof, such as “comprises” and “comprising” are to be construed in an open, inclusive sense, that is as “including but not limited to”.

The present invention is generally related to bipolar plates for fuel cells, such as phosphoric acid fuel cells, solid oxide fuel cells, and, in particular, polymer electrolyte membrane fuel cells. The present bipolar plates may also be employed in electrolyzers having an electrode assembly structure.

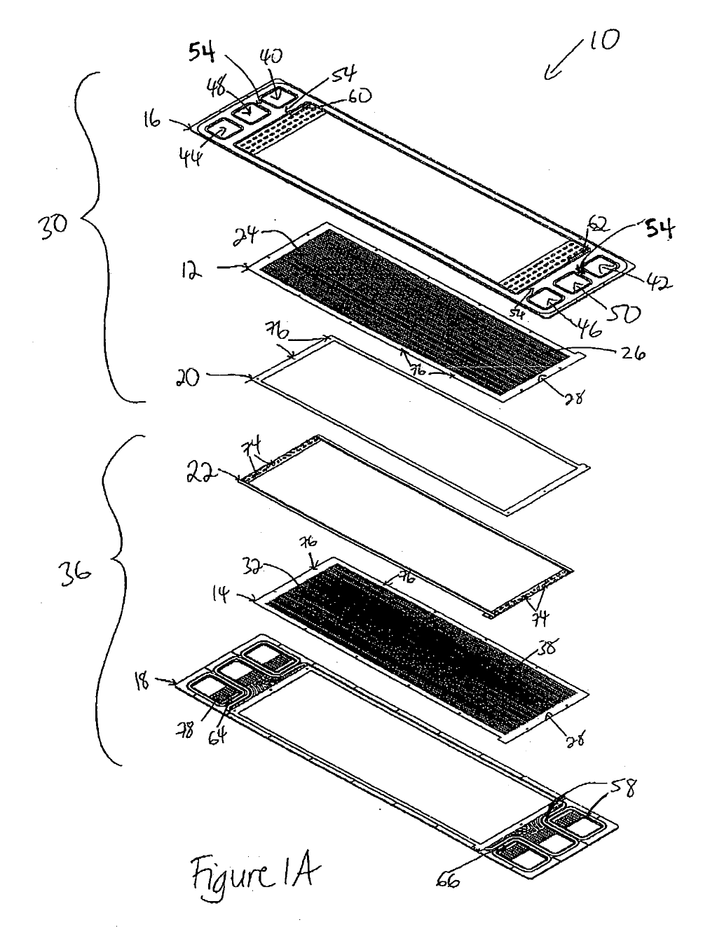

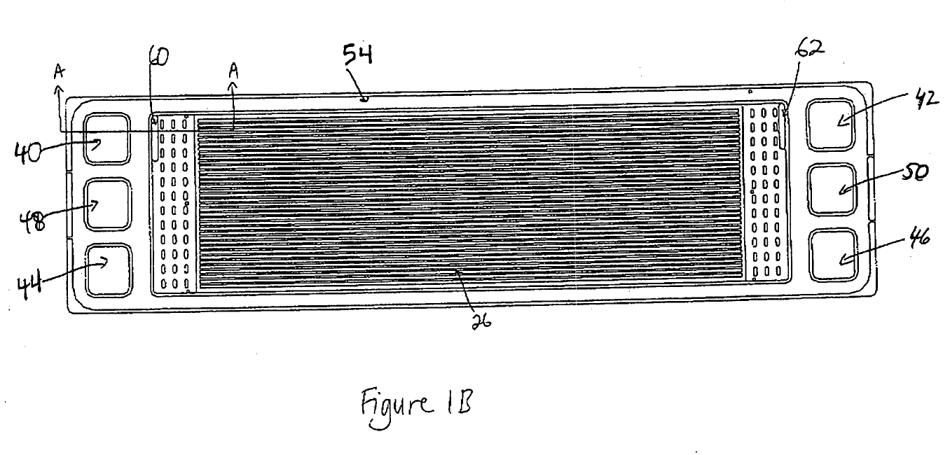

FIG. 1A shows a diagram of the individual components of an embodiment of a bipolar flow field plate 10. Plate 10 comprises an anode flow field plate 12, a cathode flow field plate 14, an anode frame 16, a cathode frame 18, an anode inner frame 20, and a cathode inner frame 22. FIG. 1B shows a top view of the bipolar flow field plate of FIG. 1A (top view from anode side of plate).

Referring to FIG. 1A, anode flow field plate 12 has an active surface 24 with anode flow channels 26, and an opposing inactive surface (not shown). Anode frame 16 is attached to peripheral edge 28 of active surface 24 of anode flow field plate 12, while anode inner frame 20 is attached to peripheral edge 28 of the inactive surface of anode flow field plate 12, to form an anode plate assembly 30. Likewise, cathode flow field plate 14 has an active surface (not shown) with cathode flow channels, and an opposing inactive surface 32. Cathode frame 18 is attached to peripheral edge 28 of the active surface of cathode flow field plate 14, while cathode inner frame 22 is attached to peripheral edge 28 of inactive surface 32 of cathode flow field plate 14 to form a cathode plate assembly 36. The inactive surfaces of the anode and cathode flow field plates cooperate to form a coolant flow field therebetween, such as coolant flow field 38 on inactive surface 32 of cathode flow field plate 14, for allowing the flow of coolant. Each of anode and cathode frames 16,18 surrounds the flow channel region of the flow field plates to allow fluids that are flowing therein to contact the corresponding electrode of the adjacent electrode assembly in a fuel cell configuration (not shown). Likewise, each of anode and cathode inner frames 20,22 also surrounds the coolant flow field region to allow coolant fluid that flows therethrough to contact the inactive surfaces of anode and cathode flow field plates 12,14.

Anode and cathode frames 16,18 are provided with manifold openings for the supply of reactants and exhaust of reaction products, as well as the supply and exhaust of coolant; namely, fuel supply manifold opening 40 and fuel exhaust manifold opening 42, oxidant supply manifold opening 44 and oxidant exhaust manifold opening 46, and coolant supply manifold opening 48 and coolant exhaust manifold opening 50.

In the case of metallic bipolar flow field plates, the flow field plates are typically joined by welding around the manifold openings and the flow field area. However, crevice corrosion may occur at the exposed weld joints during fuel cell operation, particularly in the manifold openings. By forming the manifold openings in the frames, welding of the metallic plates is not necessary, thereby reducing or eliminating crevice corrosion. One of ordinary skill in this field will understand that the manifold openings may be appropriately sized and at any number of positions, and thus the manifold openings are limited to the sizes and positions shown in any of the figures.

In addition, each of anode and cathode frames 16,18 may further contain a manifold seal groove 54 on their respective active surfaces. Manifold seal groove 54 is adaptable for receiving elastomeric and/or compressible seals that provide a gas-tight seal around when in contact with an electrode assembly (not shown) and/or with corresponding manifold openings of adjacent flow field plates (not shown).

Furthermore, anode and cathode frames 16,18 may include adhesive seal grooves 58 on their respective inactive surface around the circumference of anode and cathode flow field plates 12,14 and/or around the manifold openings for receiving adhesive for gluing the anode and cathode frames together to form a sealed bipolar flow field plate assembly. In some embodiments, seal grooves 58 have a complex cross-sectional shape, such as that described in U.S. Pat. No. 6,777,127. In further embodiments, adhesive seal grooves 58 may be omitted from one or both of the anode and cathode frames and/or the inner frame(s), as desired. In further embodiments, manifold seal grooves 54 and/or adhesive seal grooves 58 may be omitted from one or both of the anode and cathode frames and/or the inner frames, as desired.

Any suitable adhesive may be used for attaching anode and cathode frames 16,18 to peripheral edges 28 of anode and cathode flow field plates 12,14, and/or for attaching anode and cathode inner frames 20,22 to peripheral edges 28 of anode and cathode flow field plates 12,14. Suitable adhesives are compatible in the frame and plate materials employed, and are stable under fuel cell operating conditions. For example, in polymer electrolyte membrane fuel cell applications, an epoxy (e.g., acrylic-based or cyanoacrylic-based) may be used to join anode frame 16 to anode flow field plate 12, anode inner frame 20 to anode flow field plate 12, cathode frame 18 to cathode flow field plate 14, and/or cathode inner frame 22 to cathode flow field plate 14. Likewise, any suitable adhesive may be used for attaching the inactive surface of anode frame 16 to the inactive surface of cathode frame 18 and, thus, attaching anode plate assembly 30 to cathode plate assembly 36.

An adhesive may also be applied around each of the manifold openings of the anode and cathode frames to prevent leakage of the reactant and product fluids, as well as the coolant fluid, when attaching anode plate assembly 30 to cathode plate assembly 36. In one embodiment, and adhesive is used to adhesively attach the components to form a sealed anode or cathode plate assembly, and/or a sealed bipolar flow field plate. A person of ordinary skill in this field may readily select a suitable adhesive material for a this application.

In addition, anode and cathode flow field plates 12,14 further comprise a plurality of through-holes 76 as shown in FIG. 1A. During assembly, the adhesive applied between anode inner frame 20 and anode flow field plate 12 will penetrate through through-holes 76 to adhesively attach anode frame 16 to anode inner frame 20. Similarly, the adhesive applied between cathode inner frame 22 and cathode flow field plate 14 will penetrate through through-holes 76 to adhesively attach cathode frame 18 to cathode inner frame 22. In further embodiments, through-holes 76 may be omitted from one or both of anode and cathode flow field plates 12,14.

As shown in FIGS. 1A and 1B, each of the anode and cathode frames 16,18 may further contain a plurality of fluid ports 60,62,64,66. Fluid port 60 fluidly connects active surface 24 of anode flow field plate 12 to fuel supply manifold opening 40, while fluid port 62 fluidly connects active surface 24 of anode flow field plate 12 to fuel exhaust manifold opening 42. Likewise, fluid port 64 fluidly connects the active surface of cathode flow field plate 14 to oxidant supply manifold opening 44, while fluid port 66 fluidly connects the active surface of cathode flow field plate 14 to oxidant exhaust manifold opening 46.

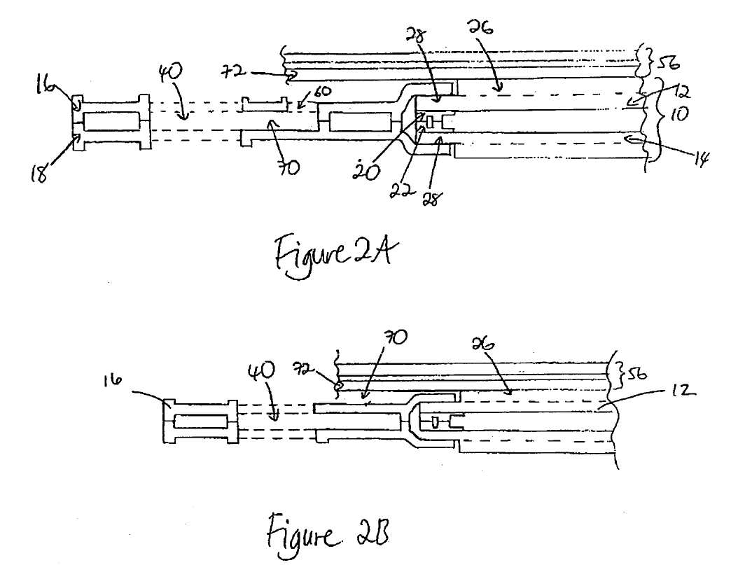

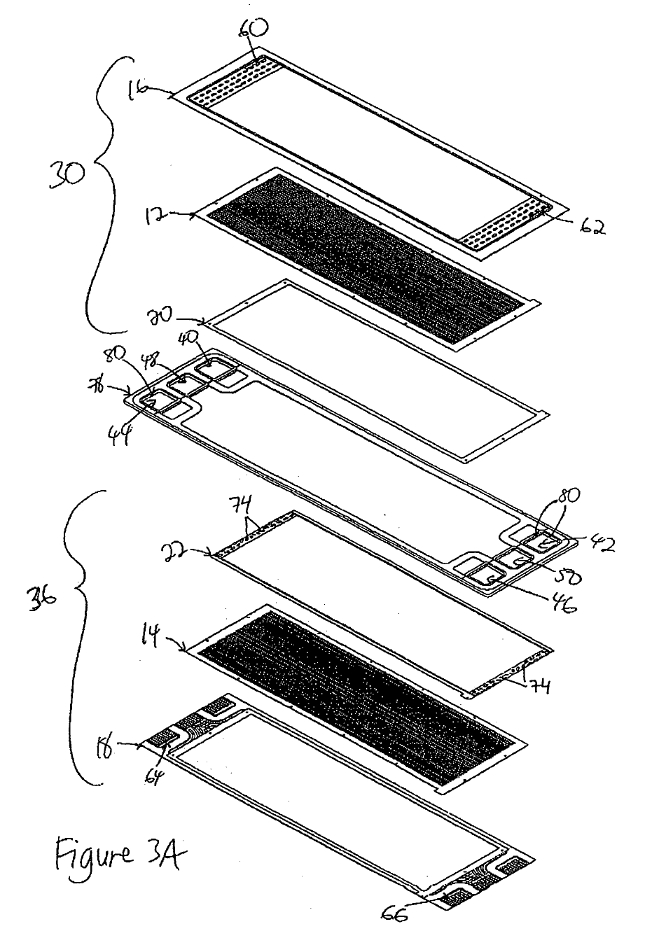

FIG. 2A is a cross-sectional view of plate 10 through region A-A in FIG. 1B. During operation, fuel is supplied via anode supply passageway 70, travels through fluid port 60, and contacts the active surface of anode flow field plate 12 and anode electrode 72 of membrane assembly 56 (membrane assembly 56 is shown in FIG. 2A to better illustrate fluid flow to the electrode, and a corresponding membrane assembly (not shown) would be associated with cathode flow field plate 14). The inactive surfaces of the adjoining anode and cathode frames 16,18 cooperate to provide anode supply passageway 70 for directing fuel from the fuel supply manifold opening to the anode electrode. Fuel exhausted from anode flow field plate 12 follows a similar path from port 62 to opening 42 (not shown). Likewise, oxidant is supplied via cathode supply passageway 78 through port 64 to the active surface of cathode flow field plate 14, and is exhausted via port 66 to opening 46. It should be understood that the anode and cathode passageways are fluidly isolated from each other, although they both traverse adjoining inactive surfaces of the same anode and cathode frames, by the use of appropriate seals and/or adhesives.

While port 60 is shown as perpendicular with respect to active surface 24, port 60, as well as any of ports 62, 64, and/or 66, may be angled as described in, for example, U.S. Pat. No. 6,232,008.

FIG. 2B shows a cross-sectional view of plate 10 according to another embodiment of the present invention. Anode supply passageway 70 is formed on the active surface of anode frame 16 such that, during operation, fuel is supplied via anode supply passageway 70 from opening 40 to the active surface of anode flow field plate 12 and anode electrode 72 or membrane assembly 56. Again, fuel may be exhausted following a similar path from the active surface of anode flow field plate 12 to opening 42 (not shown). Likewise, oxidant may also be supplied and exhausted following a similar path.

In the embodiment illustrated in FIGS. 1A and 1B, peripheral edges 28 (also referred to as “overhang”) around the anode and cathode flow channel regions of anode and cathode flow field plates 12,14 allow the anode and cathode inner frames 20,22 to be securely attached thereto. In FIG. 1A, inner frames 20,22 include transition flow fields 74 (shown on inner fram 22, but on the lower side, and thus out of view, with regard to inner frame 20). In some embodiments, forming transitional flow fields 74 in anode and cathode inner frames 20,22 may eliminate the need to form them on peripheral edges 28 of anode and cathode flow field plates 12,14. In the case of metallic plates, formation of transitional flow fields 74, or other complex features in the inner frames (such as the recesses described in co-pending application titled “Bipolar Separators with Improved Fluid Distribution”, U.S. application Ser. No. ______ (awaiting), filed Aug. 23, 2006), eliminates the need for stamping the features into peripheral edges 28, thereby reducing deformation therein. Furthermore, as mentioned earlier, stamping of metallic plates requires that reciprocal features be formed on opposing sides of the flow field plates. By forming features in the frames, reciprocal features need not be formed on opposing sides of anode and cathode flow field plate(s) 12,14. Transitional flow fields 74 are, however, optional and may be omitted from one or both of the anode and cathode frame(s) 16,18 and/or the inner frame(s) 20,22, as desired.

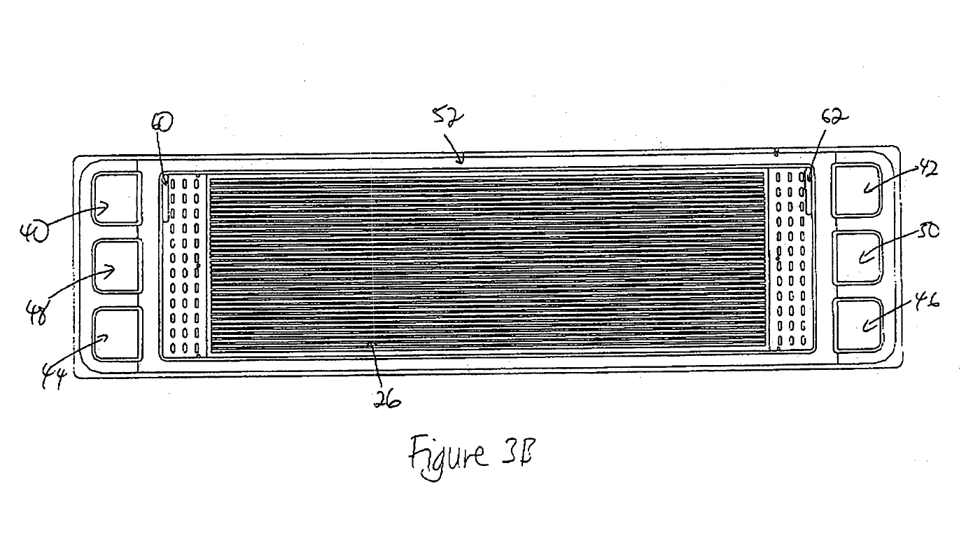

FIGS. 3A and 3B illustrate another embodiment of the present invention. Referring to FIG. 3A, a manifold frame 78 is employed between anode plate assembly 30 and cathode plate assembly 36 and surrounds the coolant flow field area of the plates. In one embodiment, manifold frame 78 is adhesively attached to anode and cathode plate assemblies 30,36. In another embodiment, manifold frame 78 is a melt processable material or an injection-moldable material, such as a silicone, a thermoplastic, or a thermoset, that joins anode plate assembly 30 to cathode plate assembly 36 as the manifold frame is formed therebetween. In any of the above embodiments, the manifold frame material may be the same material used to form the anode and cathode frames, and/or the inner frames, or a different but compatible material, if desired.

In one embodiment, anode frame 16 and anode inner frame 20 are provided with fluid ports 60,62, while cathode frame 18 and cathode inner frame 22 are provided with fluid ports 64,66. Inner frames 20,22 may also contain transition flow fields 74 (which are out of view in FIG. 3A with regard to inner fram 20). Manifold frame 78, which is interposed between anode plate assembly 30 and cathode plate assembly 36, contains manifold openings 40,42,44,46,48,50.

By forming the manifold openings in manifold frame 78, a very smooth surface is provided around inner perimeter 80 of manifold openings 40,42,44,46,48,50, and may eliminate the need for glue joints at the edges of the manifold openings. In some applications, this may assist in reducing or preventing any accumulation of water therein, thereby avoiding problems related to the freezing of water at subzero temperatures and the associated problems of cold temperature fuel cell start-up. Furthermore, manifold frame 78 may be formed with features in the manifold openings that aid in the delivery and/or removal of the reactant and product fluids, as well as the coolant fluids to and/or from the manifold openings. Although FIGS. 3A and 3B show that all the manifold openings are formed in joining frame 78, it should be understood that one or more of manifold openings 40,42,44,46,48,50 may be formed in anode and/or cathode frames 16,18 as desired.

In any of the above embodiments, anode and cathode flow field plates 12,14 may be a metallic material that has high electrical and thermal conductivity, as well as high corrosion and chemical resistance, and is compatible with the operating environment within the fuel cell. For example, the anode and cathode flow field plates may be a composite material that has a metallic or polymeric layer on the surface of a metal substrate, such as a metal carbide, metal nitride, or metal oxide, on a stainless steel or aluminum substrate. Alternatively, the anode and cathode flow field plates may comprise a metal substrate that has been surface-treated to provide high corrosion resistance and high electrical and thermal conductivity. Again, although a certain materials have been described above, it should be understood that the selection of a particular material for the flow field plate is not essential to the present invention, as a person of ordinary skill in the art will be able to select a suitable material for a given application.

In any of the above embodiments, anode and cathode frames 16,18 and anode and cathode inner frames 20,22 are a rigid, electrically-insulating material, such as a thermoplastic or a thermoset that can withstand the operating conditions of the fuel cell. In some embodiments, the rigid, electrically-insulating material is an engineered plastic with a low coefficient of thermal expansion, high chemical stability, and high temperature resistance such as, for example, Lexan® and Ultem®. Preferably, the frames should be thin, for example, less than 50 microns, to minimize the thickness of the flow field plate.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

While particular elements, embodiments, and applications of the present invention have been shown and described, it will be understood that the invention is not limited thereto since modifications may be made by those skilled in the art without departing from the spirit and scope of the present disclosure, particularly in light of the foregoing teachings.

What is claimed is:

1. A bipolar flow field plate assembly, comprising:
an anode flow field plate and a cathode flow field plate, each comprising an active surface and an opposing inactive surface;
an anode plate assembly comprising an electrically-insulating anode frame attached to the active surface of the anode flow field plate around a peripheral edge thereof and an anode inner frame attached to the inactive surface of the anode flow field plate around an opposing peripheral edge thereof; and
a cathode plate assembly comprising an electrically-insulating cathode frame attached to the active surface of the cathode flow field plate around a peripheral edge thereof and a cathode inner frame attached to the inactive surface of the cathode flow field plate around an opposing peripheral edge thereof;
wherein the inactive surfaces of the anode and cathode flow field plates, respectively, cooperate to form a coolant flow field therebetween.

2. The bipolar flow field plate assembly of claim 1 wherein at least one of the anode flow field plate and the cathode flow field plate comprises at least one flow channel on the respective active surface.

3. The bipolar flow field plate assembly of claim 1 wherein the inactive surface of at least one of the anode flow field plate and the cathode flow field plate comprises a coolant flow channel.

4. The bipolar flow field plate assembly of claim 1 wherein at least one of the anode flow field plate and the cathode flow field plate are metallic.

5. The bipolar flow field plate assembly of claim 1 wherein at least one of the anode and cathode-frames comprise a rigid thermoplastic.

6. The bipolar flow field plate assembly of claim 1 wherein the anode frame and the anode inner frame are attached to the anode flow field plate by an adhesive.

7. The bipolar flow field plate assembly of claim 1 wherein the cathode frame and the cathode inner frame are attached to the cathode flow field plate by an adhesive.

8. The bipolar flow field plate assembly of claim 1 wherein the anode frame is attached to the cathode frame around the peripheral edges thereof by an adhesive.

9. The bipolar flow field plate assembly of claim 1 wherein the anode frame is attached to the cathode frame around the peripheral edges thereof by an injection-moldable material.

10. The bipolar flow field plate assembly of claim 1 wherein at least one of the anode and cathode flow field plates further comprises at least one through-hole in the peripheral edge thereof.

11. The bipolar flow field plate assembly of claim 1 wherein at least one of the anode frame, the cathode frame, the anode inner frame, and the cathode inner frame further comprises at least one manifold opening.

12. The bipolar flow field plate of claim 11 wherein the anode frame further comprises at least one reactant stream passageway for fluidly connecting the at least one manifold opening to the active surface of the anode flow field plate, wherein the at least one reactant stream passageway traverses a portion of the inactive surface of the anode frame.

13. The bipolar flow field plate of claim 111 wherein the cathode frame further comprises at least one reactant stream passageway for fluidly connecting the at least one manifold opening to the active surface of the cathode flow field plate, wherein the at least one reactant stream passageway traverses a portion of the inactive surface of the cathode frame.

14. A method of making a bipolar flow field plate comprising the steps of:
providing an anode flow field plate and a cathode flow field plate, each comprising an active surface and an opposing inactive surface;
forming an anode plate assembly by attaching an electrically-insulating anode frame to the active surface of the anode flow field plate around a peripheral edge thereof, and attaching an anode inner frame to the inactive surface of the anode flow field plate around an opposing peripheral edge thereof;
forming a cathode plate assembly by attaching an electrically-insulating cathode frame to the active surface of the cathode flow field plate around a peripheral edge thereof, and attaching a cathode inner frame to the inactive surface of the cathode flow field plate around an opposing peripheral edge thereof; and
assembling the anode plate assembly and the cathode plate assembly such that the inactive surfaces of the anode and cathode flow field plates, respectively, cooperate to form a coolant flow field therebetween.

15. The method of claim 14 wherein the anode flow field plate and the cathode flow field plate are metallic.

16. The method of claim 14 wherein the anode frame and the cathode frame is attached to the anode flow field plate and the cathode flow field plate, respectively, by an adhesive.

17. The method of claim 16 wherein at least one of the anode and cathode flow field plates further comprise at least one opening around the peripheral edge thereof for receiving the adhesive.

18. The method of claim 14 further comprising the step of forming a manifold frame between the anode plate assembly and the cathode plate assembly during the assembly step, wherein the manifold frame effects attachment of the assemblies to each other.

19. The method of claim 18 wherein the manifold frame is injection-molded.

20. The method of claim 18 wherein the manifold frame is formed from a melt-processable material.
